(19) United States
(12) Patent Application Publication
(10) Pub. No.: US 2004/0191587 A1
(43) Pub. Date: Sep. 30, 2004

(54) Method of operating a fuel cell

(76) Inventors: Kevin Kendall, Shropshire (GB); Gary John Saunders, Cheshire (GB)

Correspondence Address: John P White, Cooper & Dunham, 1185 Avenue of the Americas, New York, PA, 10036, US

(21) Appl. No.: 10/362,221

(22) PCT Filed: Jun. 25, 2001
(86) PCT No.: PCT/GB01/02815

(30) Foreign Application Priority Data
Aug. 19, 2000 (GB) 00020478.4

(51) Int. Cl. H01M 8/04; H01M 8/12

(52) U.S. Cl. 429/17; 429/34; 429/30

(57) ABSTRACT

A solid oxide fuel cell (4) operated at about 800° C.; has a cathode supplied with oxygen along conduit (26) and an anode supplied along conduit (28) with a mixture of replacement fuel and spent anode gas. In the mixture, substantially 80% to 99% by volume of the mixture is spent anode gas. Spent anode gas leaves the cell along conduit (32) and comprises carbon dioxide and water vapour which is condensed out by condenser (34) leaving the spent anode gas richer in carbon dioxide. This enriched gas is pumped by pump (36) and bubbled at (56) into the liquid replacement fuel (50) in a reservoir (52) in which the stream of gas bubbles picks up the replacement fuel in its gaseous or vapour state from the liquid fuel bulk (50) to form the mixture which leaves the reservoir on the conduit (28) which includes desulfurisation unit (29).

This invention concerns a method of operating a fuel cell and also concerns a fuel cell system.

One object of the invention is to provide a method of operating a fuel cell, or to provide a fuel cell system, capable of enabling higher hydrocarbon and difficult fuels to be used but at the same time reducing, or at least not unduly increasing, deposited carbon in the cell or outside it.

According to a first aspect of the invention a method of operating a fuel cell comprises supplying oxygen to a cathode of the fuel cell and supplying a gaseous or vapour mixture of spent anode gas and replacement fuel to an anode of the fuel cell, said mixture comprising at least substantially 80% by volume of spent anode gas, the fuel being capable of reacting with oxygen ions and providing electrons to create electric current, forming the gaseous or vapour mixture comprising said fuel and spent anode gas, said fuel cell providing aforesaid spent anode gas as gaseous exhaust from the anode, and said spent anode gas comprising carbon dioxide.

The expression “replacement fuel” used herein is intended to mean fuel supplied to the anode of the fuel cell to replace, at least in part, fuel previously supplied to the anode and consumed by the fuel cell.

Spent anode gas may comprise predominantly carbon dioxide. Said carbon dioxide may be predominant by volume.

Spent anode gas may also comprise any one of water vapour, unreacted fuel, or partially oxidised fuel, or a combination of any two or more thereof.

Said mixture may comprise spent anode gas lying within a range of substantially 80% to substantially 99% by volume of the mixture or lying within (or at an extremity of) any range having a lower limit of substantially 80%, or substantially 85%, or substantially 90% by volume and an upper limit greater than the lower limit and substantially 85%, or substantially 90%, or substantially 95%, or substantially 99% by volume.

If desired, the spent anode gas may be subjected to a water extraction experience, for example by use of water extraction means, to extract water from the gas to leave the spent water gas richer in carbon dioxide. The spent anode gas may be subject to a condensing experience to condense out liquid water from the gas to leave the spent anode gas richer in carbon dioxide.

Forming the gaseous or vapour mixture may comprise adding aforesaid spent anode gas comprising said carbon dioxide to said fuel which may be in a liquid state.

The fuel may be provided in an enclosed reservoir leaving a top space above the fuel level in the reservoir, the spent anode gas may pass through the top space, and the said mixture may leave the top space to be supplied to the anode. Thus to at least some extent the spent anode gas, which may be predominantly carbon dioxide, has an effect of purging the top space of fuel.

The spent anode gas may be bubbled into the fuel. If desired, the spent anode gas may be pumped into the fuel.

If desired the spent anode gas or said mixture may be subjected to a desulfurisation treatment.

The fuel cell may be a solid oxide electrolyte fuel cell. If desired, the fuel cell may comprise a tubular cell comprising a tubular wall comprising solid oxide electrolyte. Aforesaid solid oxide electrolyte may comprise zirconium oxide, and/or cerium oxide and/or one or more other ionic conductors.

Said anode may comprise a metal cermet material. Said metal cermet material may comprise one or more of nickel, cerium, zirconium and/or oxides thereof, for example ceria or zirconia, and/or other catalytic and/or metallic additives.

Said cathode may comprise a lanthanum strontium manganite material and/or other mixed conducting species.

The fuel cell may be operated at a temperature of at least substantially 600° C. Preferably, the fuel cell is operated at a temperature of substantially 800° C.

Preferably, the fuel cell may produce utilizable electrical power.

Said spent anode gas may be pumped by electrically powered pump means powered by at least some of said utilizable electrical power.

Preferably the fuel cell produces utilizable sensible heat. Aforesaid sensible heat may be recoverable from heated coolant subsequent to the coolant being used to extract heat from the fuel cell to cool the latter.

Aforesaid sensible heat may be recoverable from water condensed as heated water from said spent anode gas.

A path carrying aforesaid spent anode gas may comprise fluid pressure relief means.

Said fuel may be capable of reacting exothermically with oxygen ions.

Said fuel may comprise biofuel. If desired said fuel may comprise animal or livestock manure. For example, the animal or livestock manure may be pig manure. Said fuel may comprise slurry comprising said manure. The biofuel may be a fermentation product. The fermentation product may be or comprise or be derived from rotting vegetable material. The fermentation product may be in slurry form.

Suitable fuels may be or comprise any one of the following or a mixture comprising any two or more of the said following:

(i) methanol and/or other alcohols, for example ethanol, propanol; etc;

(ii) formaldehyde and/or other aldehydes, for example acetaldehyde, etc;

(iii) formic acid and/or other organic acids, for example acetic acid, butyric acid, etc;

(iv) alkanes, for example methane, ethane, butane, pentane, etc;

(v) higher alkanes, for example octane, nonane, . . . cetane . . . etc;

(vi) optimised mixtures [for example optimised mixtures comprising one or more of the above at (i), (ii), (iii), (iv) and (v)] wherein one or more low molecular weight fuels aid processing of one or more higher molecular weight fuels;

(vii) toxic and/or nuisance molecules or compounds, for example one or more amines, ammonia, one or more dioxins.

Preferably the fuel may be heated. The fuel may be heated before said spent anode gas comprising carbon dioxide is mixed therewith and/or the fuel may be heated simultaneously with mixing therewith of said spent anode gas comprising carbon dioxide. The temperature may be controlled. The temperature may be controlled to optimise presentation of fuel to the fuel cell.

According to a second aspect of the invention a fuel cell system comprises at least one fuel cell, means to supply oxygen to a cathode of the fuel cell, means to supply a gaseous or vapour mixture of spent anode gas and replacement fuel to an anode of the fuel cell, said mixture comprising at least substantially 80% by volume of spent anode gas, and means to form said gaseous or vapour mixture, and wherein said fuel is capable of reacting with oxygen ions to create electric current, said fuel cell provides aforesaid spent anode gas as gaseous exhaust from the anode, and said spent anode gas comprises carbon dioxide.

The system may comprise heating means to heat said replacement fuel. Said heating means may heat the replacement fuel prior to aforesaid spent anode gas and the replacement fuel mixing, and/or may heat the replacement fuel simultaneously with the mixing of the spent anode gas and said replacement fuel.

If desired means may be provided whereby an electrical conducting contact of at least one electrode of the fuel cell is clipped into position. Said contact may clip against an interior of the fuel cell. Said contact may resiliently engage the fuel cell. Said contact may be tubular. If desired said fuel cell may be a tubular fuel cell. Said contact may engage an interior of a said tubular fuel cell.

The invention will now be further described, by way of example, with reference to the accompanying drawings in which:

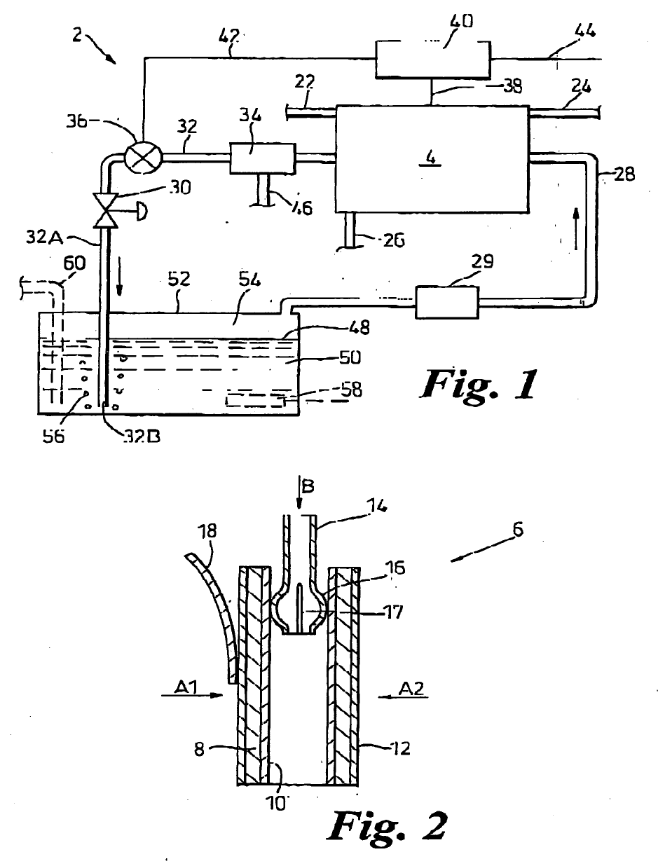

FIG. 1 is a diagrammatic view of a fuel cell system formed according to a second aspect of the invention operating in accordance with the method according to the first aspect of the invention, and

FIG. 2 is section of a fragment of a fuel cell which may be used in the system in FIG. 1.

With reference to the accompanying drawings a fuel cell system is indicated at 2 comprising a battery 4 comprising one or, preferably, a plurality of fuel cells electrically connected together in known manner. The or each fuel cell is a solid oxide fuel cell wherein the electrolyte is a suitable solid electrolyte, for example zirconium oxide. The solid oxide electrolyte may be pervious to oxygen ions but is regarded as substantially impervious to oxygen atoms or molecules. The or each fuel cell has an anode which may be of or may comprise a nickel cermet material and a cathode which may be of or comprise a lanthanum strontium manganite material.

An example of the or each solid oxide fuel cell which may be used in battery 4 is indicated at 6 in FIG. 2. The solid oxide fuel cell 6 is a tubular fuel cell in which the solid oxide electrolyte, for example zirconium oxide, forms a tubular wall 8, which may be cylindrical, having an anode coating 10, for example nickel cermet material, on its inner surface and a cathode coating 12, for example lanthanum strontium manganite material, on its outer surface. An open ended tubular, electrically conducting contact 14 inserted into the interior of the fuel cell 6 has a bulging or segmental spherical wall part 16 which clips or resiliently engages against the anode 10 to make electrical contact Therewith when pushed into the fuel cell; the resilient engagement being assisted by a plurality of axial slits 17 (only one shown) in the wall of contact 14 at the bulge 16. Another electrical conducting contact 18 is in electrical contact with the cathode 12. The contacts 14, 18 may make electrical contact or connection with an external circuit (not shown) on, for example, a circuit board whereby desired parallel and/or series connections of fuel cells forming battery 4 can be effected. In use, air to provide the required oxygen (from which the desired oxygen ions are derived) may be supplied to the exterior of the fuel cell 6 as suggested by arrows A1, A2, whilst a suitable fuel (replacement fuel) capable of reacting with oxygen ions and providing electrons to create electric current is supplied to the interior of the fuel cell through tubular contact 14 as suggested by arrow B.

The solid oxide fuel cell battery 4 is operated at a temperature of at least substantially 600° C., and more preferably at a temperature of substantially 800° C. or thereabout.

To maintain the fuel cell(s) at a desired operating temperature suitable coolant can be supplied to battery 4 along flow couduit 22 to extract heat from the battery and leave through return conduit 24 so the coolant can be re-circulated in an any suitable known manner back to the flow conduit 22 after being cooled by passage through heat exchange means (not shown) extracting heat from the coolant. The extracted sensible heat may be used for any appropriate purpose, for example heating another fluid, for example air for space or other heating, or a liquid which may be water. Such heated water may be used for space or other heating, or to provide steam and/or heated process water and/or washing water. Atmospheric air to provide the required oxygen is supplied to the fuel cell battery 4 through inlet conduit 26 and suitable fuel, in the form of gas or vapour is supplied to the battery along fuel inlet conduit 28 which may include a desulfurisation unit 29.

Spent anode gas from the fuel cell(s) leaves the battery 4 via exhaust conduit 32 which includes a condenser 34 and an electrically powered pump 36 which may be a peristaltic pump.

Electric power generated by the fuel cell battery 4 is supplied on line 38 to a control 40 from which a suitable proportion of the electrical power is supplied on line 42 to power the pump 36. The remainder of the electrical power is supplied by the control 40 to line 44 from which it can be taken for some useful purpose requiring electric power.

The spent anode gas in conduit 32 comprises unreacted fuel, partially oxidised fuel, carbon dioxide and hot water vapour or steam. The water vapour or steam is extracted by water extraction means to extract water from the spent anode gas to leave the spent anode gas richer in carbon dioxide. In the drawing the hot water vapour or steam is condensed out into hot liquid water in the condenser 34 from which the hot water leaves via water outlet conduit 46 thereby leaving the remaining spent anode gas richer in carbon dioxide gas and unreacted or partially oxidised fuel which is pumped by pump 36 into conduit extension 32A which includes a pressure relief valve 30 to ensure the pressure of a replacement fuel and spent anode gas gaseous or vapour mixture (described below) reaching the battery 4 does not exceed a predetermined desired maximum value. Sensible heat from the hot water from conduit 46 can be extracted using known heat exchange means to be used for any suitable useful purpose, for example to provide heated fluid, for example, heated air, heated water or steam.

Upstream and/or downstream of the condenser 34, the spent anode gas in conduit 32 may comprise predominantly carbon dioxide. The carbon dioxide may be predominant by volume.

Conduit extension 32A ends at 32B below the level 48 of liquid fuel 50 in an enclosed tank or reservoir 52 in which the fuel in a gaseous or vapour state may exist in reservoir top space 54 above the liquid level 48. Pumped spent anode gas comprising carbon dioxide (and unreacted or partially oxidised fuel to be re-cycled) passes down the extension 32A and emerges at end 32B as a stream of bubbles 56. This gas stream picks up the replacement fuel in its gaseous or vapour state from the liquid fuel bulk 50 and mixes with the gaseous replacement fuel. The spent anode gas (which may be predominantly carbon dioxide) can act as a purging gas through the reservoir top space 54. The gaseous fuel and spent anode gas mixture leaves the top space 54 and travels along the conduit 28 to the battery 4. Said mixture comprises spent anode gas lying within a range of substantially 80% to substantially 99% by volume of the mixture or lying within or at an extremity of any range having a lower limit of substantially 80%, or substantially 85%, or substantially 90% by volume and an upper limit greater than the lower limit and substantially 85%, or substantially 90%, or substantially 95%, or substantially 99% by volume.

If desired gasification or vaporisation of the bulk liquid fuel 50 may be encouraged by heating the fuel, for example by use of a heater 58. The heater 58 may be heated electrically, for example by electric power from battery 4, or may be heated using heat derived from operation of the battery.

If desired, means, for example a conduit 60, may be provided for replenishing the bulk liquid fuel 50 in the reservoir 52. If desired liquid fuel supplied through conduit 60 may be pre-heated.

Any suitable liquid fuel or fuel mixture may be used including higher hydrocarbons. Preferably a biofuel is used. By biofuel we mean fuel from biological material. The biofuel may be:

(a) a slurry comprising animal or livestock manure and/or

(b) a fermentation product

The animal or livestock manure may be farm animal or livestock manure, for example pig manure. The fermentation product may be or comprise or be derived from rotting vegetable material and may be in slurry form.

### EXAMPLE 1

Liquid fuel 50 may be methanol in aqueous solution at room temperature through which the exhaust gas products are bubbled at 56 whereby the gas stream picks up methanol vapour and the mixture of methanol vapour and exhaust gas products is supplied as fuel to the solid electrolyte fuel cell battery 4.

### EXAMPLE 2

Liquid fuel 50 may be ethanol solution, acetic acid solution, formic acid solution or a combination of any two thereof or all three. Preferably the liquid fuel 50 is heated to obtain a suitable vapour pressure in the gaseous stream passing along conduit 28 to the battery 4.

### EXAMPLE 3

Liquid fuel 50 may be ammonia solution. Preferably the ammonia solution is heated, for the same reason as in Example 2.

### EXAMPLE 4

Liquid fuel 50 may be a slurry comprising pig manure. Preferably the slurry is heated, for the same reason as in Example 2.

A particular advantage of the invention is that the fuel cell battery 4 may be fuelled by waste slurries, for example fermented waste or farm waste, an example of farm waste being a slurry comprising the manure from farm animals or livestock. This has a benefit of using noxious or toxic waste products.

Another benefit is that only one fuel stream, i.e. the gaseous mixture stream on conduit 28, has to be controlled and/or maintained.

A further benefit is that the system can use dilute or depleted fuels as said replacement fuel down to substantially 20% by volume of replacement fuel in the replacement fuel and spent anode gas mixture or preferably substantially 10% by volume of said replacement fuel or possibly substantially 5% to substantially 1% by volume of replacement fuel in the mixture.

1-32. (Cancel)

33. A method of operating a fuel cell comprising supplying oxygen to a cathode of the fuel cell and supplying one of a gaseous and vapor mixture of spent anode gas and replacement fuel to an anode of the fuel cell, said mixture comprising at least substantially 80% by volume of spent anode gas, the fuel being capable of reacting with oxygen ions and providing electrons to create electric current, forming the one of a gaseous and vapor mixture comprising said fuel and spent anode gas, said fuel cell providing the aforesaid spent anode gas as gaseous exhaust from the anode, and said spent anode gas comprising carbon dioxide.

34. A method as claimed in claim 33 in which said spent anode gas comprises predominantly carbon dioxide.

35. A method as claimed in claim 33 in which the mixture comprises spent anode gas lying within a range of substantially 80% to substantially 99% by volume of the mixture or lying within or at an extremity of any range having a lower limit of substantially 80%, or substantially 85%, or substantially 90% by volume and an upper limit greater than the lower limit and substantially 85%, or substantially 90%, or substantially 95%, or substantially 99% by volume.

36. A method as claimed in claim 33 in which said gaseous exhaust further comprises water vapor, and extracting water out of the gaseous exhaust to leave aforesaid spent anode gas richer in carbon dioxide which richer spent anode gas is subsequently mixed with said replacement fuel to form said mixture supplied to the anode.

37. A method as claimed in claim 33 in which said gaseous exhaust further comprises water vapor, and condensing water out of the gaseous exhaust to leave aforesaid spent anode gas richer in carbon dioxide which richer spent anode gas is subsequently mixed with said replacement fuel to form said mixture supplied to the anode.

38. A method as claimed in claim 33 in which forming the one of a gaseous and vapor mixture comprises adding aforesaid spent anode gas to said fuel which is in a liquid state.

39. A method as claimed in claim 38 in which the fuel is provided in an enclosed reservoir having a top space above the fuel level in the reservoir, the spent anode gas is passed through said top space, and said mixture is supplied from the top space to the anode.

40. A method as claimed in claim 39 in which the spent anode gas passing through the top space provides a purging effect therein.

41. A method as claimed in claim 38 in which the spent anode gas is bubbled into the fuel.

42. A method as claimed in claim 33 in which the spent anode gas further comprises at least one of unreacted fuel, partially oxidized fuel, and a combination of the two.

43. A method as claimed in claim 33 in which the spent anode gas is subjected to desulphurization treatment.

44. A method as claimed in claim 33 in which the fuel comprises slurry.

45. A method as claimed in claim 33 in which the fuel comprises on of animal and livestock manure.

46. A method as claimed in claim 45 in which the fuel comprises pig manure.

47. A method as claimed in claim 33 in which the fuel comprises a fermentation product.

48. A method as claimed in claim 47 in which the fermentation product comprises or is derived from rotting vegetable material.

49. A method as claimed in claim 33 in which said fuel comprises any one of the following or comprises a mixture comprising any two or more of the said following:
(i) methanol and/or one or more other alcohols;
(ii) formaldehyde and/or one or more other aldehydes;
(iii) formic acid and/or one or more other organic acids;
(iv) one or more alkanes;
(v) one or more higher alkanes;
(vi) an optimized mixture wherein one or more low molecular weight fuels aid processing of one or more higher molecular weight fuels;
(vii) one or more toxic and/or one or more nuisance molecules or compounds.

49. A method as claimed in claim 48 in which a said optimized mixture comprises at least one of any compound identified at (i), (ii), (iii), (iv), (v) and mixtures thereof.

50. A method as claimed in claim 48 in which said toxic and/or nuisance molecule or compound is selected from a group comprising ammonia, amines, dioxins and mixtures thereof.

51. A method as claimed in claim 33 in which the cell is operated at a temperature of at least substantially 600° C.

52. A method as claimed in claim 51 in which the fuel cell is operated as a temperature of substantially 800° C.

53. A method as claimed in claim 33 in which at least one of the steps of heating said replacement fuel prior to aforesaid spent anode gas and the replacement fuel mixing and heating the replacement fuel simultaneously with mixing of the spent anode gas and said replacement fuel is included.

54. A fuel cell system comprising
(i) at least one fuel cell;
(ii) first supply means to supply oxygen to a cathode of fuel cell;
(iii) second supply means to supply one of a gaseous and vapor mixture of spent anode gas and replacement fuel to an anode of the fuel cell, where said second supply means is capable of supplying a mixture comprising at least substantially 80% by volume of spent gas; and
(iv) means to form said one of a gaseous and vapor mixture, and wherein said fuel cell is arranged to allow said replacement fuel cell is arranged to allow said replacement fuel to react with oxygen to create electric current, and said fuel cell is arranged to provide the aforesaid spent anode gas as gaseous exhaust from the anode, said gaseous exhaust comprises carbon dioxide.

55. A fuel cell system as claimed in claim 54 in which said spent anode gas comprises predominantly carbon dioxide.

56. A system as claimed in claim 54 in which the mixture comprises spent anode gas lying within a range of substantially 80% to substantially 99% by volume of the mixture or lying within or at an extremity of any range having a lower limit of substantially 80%, or substantially 85%, or substantially 90% by volume and an upper limit greater than the lower limit and substantially 85%, or substantially 90%, or substantially 95%, or substantially 99% by volume.

57. A system as claimed in claim 54 in which said gaseous exhaust further comprises water vapor; and said system further comprising water extracting means to extract water from the gaseous exhaust to leave aforesaid spent anode gas richer in carbon dioxide which richer spent anode gas is subsequently mixed with said replacement fuel to form said mixture supplied to the anode.

58. A system as claimed in claim 54 in which said gaseous exhaust further comprises water vapor, and said system further comprising a condenser to condense out water from the gaseous exhaust to leave aforesaid spent anode gas richer in carbon dioxide which richer spent anode gas is subsequently mixed with said replacement fuel to form said mixture supplied to the anode.

59. A system as claimed in claim 54 in which forming the gaseous or vapor mixture comprises adding aforesaid spent anode gas to said fuel which is in a liquid state.

60. A system as claimed in claim 59 in which an enclosed reservoir is provided to hold said fuel with a reservoir top space above the fuel level in the reservoir when the system is in use, means to supply spent anode gas into the reservoir for said gas to pas through the top space, and means to supply said mixture from the top space to the anode.

61. A system as claimed in claim 54 in which the desulphurization means is provided to subject the spent anode gas to desulphurization treatment.

62. A system as claimed in claim 54 in which the fuel cell is a solid oxide fuel cell.

63. A system as claimed in claim 62 in which the fuel cell comprises a tubular cell comprising a tubular wall comprising solid oxide electrolyte.

64. A system as claimed in claim 54 in which an electrical conducting contact of at least one electrode of the fuel cell is clipped into position.

65. A system as claimed in claim 64 in which the contact clips against an interior of the fuel cell.

66. A system as claimed in claim 65 in which said contact is tubular.

67. A system as claimed in claim 54 in which the cell is operated at a temperature of at least substantially 600° C.

68. A system as claimed in claim 67 in which the cell is operated at a temperature of substantially 800° C.

69. A system as claimed in claim 54 in which a path carrying aforesaid spent anode gas comprises fluid pressure relief means.

70. A system as claimed in claim 54 in which heating means is provided to effect at least one of heating said replacement fuel prior to aforesaid spent anode gas and the replacement fuel mixing and heating the replacement fuel simultaneously with mixing of the spent anode gas and said replacement fuel.
